(19) United States
(12) Patent Application Publication
(10) Pub. No.: US 2017/0299884 A1
(43) Pub. Date: Oct. 19, 2017

(54) PAIR OF SPECTACLES ADJUSTABLE DEPENDING ON THE PUPILLARY DISTANCE OF AN INDIVIDUAL

(71) Applicant: MAGNYS, Ecully (FR)

(72) Inventors: Denis Thoral, TASSIN LA DEMI LUNE (FR); Francis LEPAGE, DOMMARTIN (FR)

(21) Appl. No.: 15/516,195

(22) PCT Filed: Sep. 24, 2015
(86) PCT No.: PCT/FR2015/052555

§ 371 Date: Mar. 31, 2017

(30) Foreign Application Priority Data
Oct. 2, 2014 (FR) 14/59416

(51) Int. Cl. G02C 5/04

(52) U.S. Cl. CPC G02C 5/045; G02C 2200/18; G02C 2200/22

(57) ABSTRACT

The present invention relates to a spectacle frame comprising: a front face, on which the at least one lens is intended to be fastened; a first temple and a second adjusting device temple each attached on one end of the front face; and a first adjusting device intended to adjust the position of the at least one lens relative to the front face of the frame, the first adjusting device comprising at least one first positioning element intended to cooperate with at least one second positioning element of a second adjusting device belonging to the at least one lens, characterized in that the first adjusting device is arranged to define a set of relative positions of the at least one second positioning element relative to the frame disposed on a curved line comprised in an inclined plane relative to a reference plane comprising the optical axes in far vision of the eyes of a user. The present invention also relates to a spectacle lens.

### CROSS REFERENCE TO RELATED APPLICATIONS

This application is a National Stage of PCT Application No. PCT/FR2015/052555 filed on Sep. 24, 2015, which claims priority to French Patent Application No. 14/59416 filed on Oct. 2, 2014, the contents each of which are incorporated herein by reference thereto.

### TECHNICAL FIELD

The present invention relates to a spectacle frame and to at least one spectacle lens whose position is adjustable relative to the frame.

### BACKGROUND

The pupillary distance of human beings may vary from a distance of up to ten millimeters from one individual to another. Usually, the lenses of the spectacles are adapted to the pupillary distance of each individual during machining. A machining of custom-made lenses for each individual entails significant costs, affecting the user, and significant delivery times.

It is known in the state of the art to make spectacles whose lens position may vary relative to the frame. For example, the document U.S. Pat. No. 4,997,267 describes a solution for adjusting the spectacle lenses relative to a frame. The front face of the frame has several notches allowing the insertion of a holding element in position, secured to the lens. In order to guarantee a sufficient level of strength, the notches have relatively high dimensions relative to the dimensions of the lens. The adjustment of the position of the lenses therefore does not have an optimum accuracy.

Furthermore, considering the current manufacturing modes of optical lenses, a linear displacement of the lens relative to the frame results in a modification of the optical correction.

### BRIEF SUMMARY

The present invention aims to solve all or part of the aforementioned drawbacks.

To this end, the present invention concerns a spectacle frame comprising:
a front face, on which the at least one lens is intended to be fastened;
a first temple and a second temple each attached on one end of the front face; and
a first adjusting device intended to adjust the position of the at least one lens relative to the front face of the frame, the first adjusting device comprising at least one first positioning element intended to cooperate with at least one second positioning element of a second adjusting device belonging to the at least one lens,

characterized in that the first adjusting device is arranged to define a set of relative positions of the at least one second positioning element relative to the frame, disposed on a curved line comprised in an inclined plane relative to a reference plane comprising the optical axes in far vision of the eyes of a user.

The present invention also concerns a spectacle lens intended to be fastened to a frame, comprising a second adjusting device intended to adjust the position of the lens relative to the frame, the second adjusting device comprising at least one second positioning element intended to cooperate with at least one first positioning element of a first adjusting device belonging to the frame,

characterized in that the second adjusting device is arranged to define a set of relative positions of the at least one first positioning element relative to the lens disposed on a curved line comprised in an inclined plane relative to a reference plane comprising the optical axes in far vision of the eyes of a user.

Thanks to the dispositions according to the invention, the adjustment of the position of the lenses may be very thin and adequate to the variation of the pupillary distance between the individuals. The holding of the lenses in position is ensured by the cooperation between the first and the second plurality of positioning elements, which also allows a robustness of the assembly adapted to the use of spectacles.

Furthermore, the displacement path of the lens along the curved line allows keeping the optimum optical correction for each position of the lens.

Furthermore, the current optical lenses having a curvature, a linear displacement or along a determined plane would limit the length of the path of the lens. Indeed, the lens would no longer be aligned with the frame and would be hardly capable of being connected thereto.

According to optional characteristics of the frame and of the lens according to the invention:
the curved line is a circle portion;
the inclined plane has a first component of inclination relative to the reference plane; in particular the inclined plane is inclined upwards at an angle relative, on the one hand, to a straight line inscribed in the reference plane, passing through the center of the eye and through the center of the pupil and on the other hand, to a straight line inscribed in the reference plane, passing through the center of the eye and through the center of the pupil.
the inclined plane has a second component of inclination relative to a straight line passing through the center of the eyes of the user;
the inclined plane has a second component of inclination relative to a median plane of the head of the user;
the at least one first positioning element and the second at least one positioning element are arranged to be intended to cooperate in a form-fitting manner;
the frame, respectively the lens, comprising a first plurality of first positioning elements, respectively a plurality of second positioning elements;
the spacing between two subsequent positioning elements among the first plurality of positioning elements or the second plurality of positioning elements respectively is arranged to index a plurality of relative positions between the frame and the lens;
a positioning element among the first plurality of positioning elements or the second plurality of positioning elements respectively has an elongated shape along a direction transverse to the curved line.

According to an aspect of the frame according to the invention, the curved line is inscribed between a proximal surface and a distal surface of a lens intended to be fastened on the frame.

According to an aspect of the frame according to the invention, the profile of the front face follows the curved line.

According to an aspect of the lens according to the invention, the lens comprises a proximal face and a distal face between which the curved line is inscribed.

According to an aspect of the invention, the angle of inclination of the inclined plane relative to the reference plane is comprised between 0 degree and 35 degrees, and in particular between 10 degrees and 25 degrees. Preferably, the angle of inclination of the inclined plane relative to the reference plane has a value of 17 degrees.

According to an aspect of the invention, the circle portion has a radius comprised between 80 millimeters and 200 millimeters. More particularly, the circle portion has a radius comprised between 110 millimeters and 170 millimeters. Preferably, the circle portion has a radius of 140 millimeters.

According to an aspect of the invention, the frame comprises at least one first retaining element intended to cooperate with at least one second retaining element belonging to the at least one lens and intended to hold the at least one lens in position relative to the frame.

According to an aspect of the invention, the optical axis of the lens is inclined relative to the horizontal by an angle corresponding to the pantoscopic angle.

According to an aspect of the invention, the curved line is disposed at the intersection of the inclined plane and a reference surface.

According to an aspect of the invention, the reference surface is transverse to the optical axis, preferably having an angle of 85 to 95°, and preferably perpendicular to the optical axis.

According to an aspect of the invention, the reference surface is spherical.

According to an aspect of the invention, the front face is made of an elastically deformable material.

According to an aspect of the invention, the front face is composed of a first part connected to the temples, and of a second part fastened facing the first part at the first adjusting device.

According to an aspect of the invention, the first part and the second part are fastened to each other by centering elements.

According to an aspect of the invention, the first part comprises the first plurality of positioning elements and/or the transverse retaining element.

According to another possibility, the second part comprises the first plurality of positioning elements and/or the transverse retaining element.

According to an aspect of the invention, the first part and the second part comprise the first plurality of positioning elements and the first retaining element.

According to an aspect of the invention, the front face comprises an upper portion comprising a clearance zone at the adjusting device intended to receive an elastic stop element fastened to the at least one lens.

According to an aspect of the invention, the lens comprises a protuberance on which the second adjusting device and/or the second retaining element is/are disposed.

According to an aspect of the invention, two subsequent positioning elements among the first plurality of positioning elements or the second plurality of positioning elements respectively are distant of a predetermined spacing in a direction along the curved line.

According to an aspect of the invention, the spacing between two positioning elements among the first plurality of positioning elements or the second plurality of positioning elements respectively is 1 millimeter.

According to an aspect of the invention, the first retaining element is a groove or a gadroon and the second retaining element is a gadroon or a groove respectively.

According to an aspect of the invention, the lens comprises a framework and an optical portion.

According to an aspect of the invention, the framework comprises the adjusting device intended to adjust the position of the lens relative to the frame.

According to an aspect of the invention, the framework is disposed on at least one part of the periphery of the optical portion.

According to an aspect of the invention, the framework comprises a support and a retaining element.

According to an aspect of the invention, the support comprises the adjusting device.

According to an aspect of the invention, the framework comprises a metal portion.

According to an aspect of the invention, the retaining element comprises a protruding portion formed with the support.

According to an aspect of the invention, the retaining element comprises a flexible strip, for example a nylon wire.

According to an aspect of the invention, the optical portion is held by the framework in a form-fitting manner.

According to an aspect of the invention, the optical portion comprises a retaining member, on at least one part of the periphery of the optical portion, arranged to cooperate with the retaining element of the framework.

According to an aspect of the invention, the retaining member is constituted by a slot on at least one part of the periphery of the optical portion, arranged to cooperate with the retaining element of the framework.

According to an aspect of the invention, the framework and the optical portion are removably fastened.

According to an aspect of the invention, the retaining element is removably fastened by fastening elements of the support at a nose pad of the spectacle frame and/or to the first temple and/or to the second temple.

According to an aspect of the invention, the retaining element is constituted by a protruding portion formed with the support on a first portion of the framework and by a flexible strip on a second portion of the framework.

According to an aspect of the invention, the optical portion may be retained by a flexible strip on an upper portion of the lens and by a protruding portion of the support on a lower portion.

According to an aspect of the invention, the optical portion is retained by a flexible strip on a lower portion of the lens and by a protruding portion of the support on an upper portion.

The lower and upper portions are appreciated when the pair of spectacles is worn by a user standing such that his eyes are disposed at the same height relative to a horizontal reference. The invention also relates to a pair of spectacles comprising a frame in accordance with any one of the aforementioned characteristics, and at least one lens in accordance with any one of the aforementioned characteristics.

### BRIEF DESCRIPTION OF THE DRAWINGS

Other characteristics and advantages of the present invention will appear in the light of the following description and on examining the appended figures, in which:

FIG. 1 represents a pair of spectacles;

FIGS. 2a, 2b, 2c, 2d represent the frame of a pair of spectacles;

FIG. 3 represents a spectacle lens;

FIG. 4 represents the position of a spectacle lens relative to an eye;

FIG. 5 represents the geometrical construction underlying the position of the spectacle lens relative to the eye;

FIG. 6 represents the insertion of the spectacle lenses into the frame;

FIGS. 7a and 7b represent relative positions of the spectacle lenses relative to the frame;

FIG. 8 represents an embodiment in which the position of the spectacle lens relative to the eye is different;

FIG. 9 represents a different embodiment of cooperation between the lenses and the frame;

FIGS. 10a, 10b, 10c, 10d represent an embodiment in which the lenses are not detachable from the frame; and

FIGS. 11a, 11b, 11c and 11d represent a spectacle lens according to an embodiment in which the lens comprises a framework and an optical portion.

In all of these figures, identical or similar references refer to identical or similar members or set of members.

### DETAILED DESCRIPTION

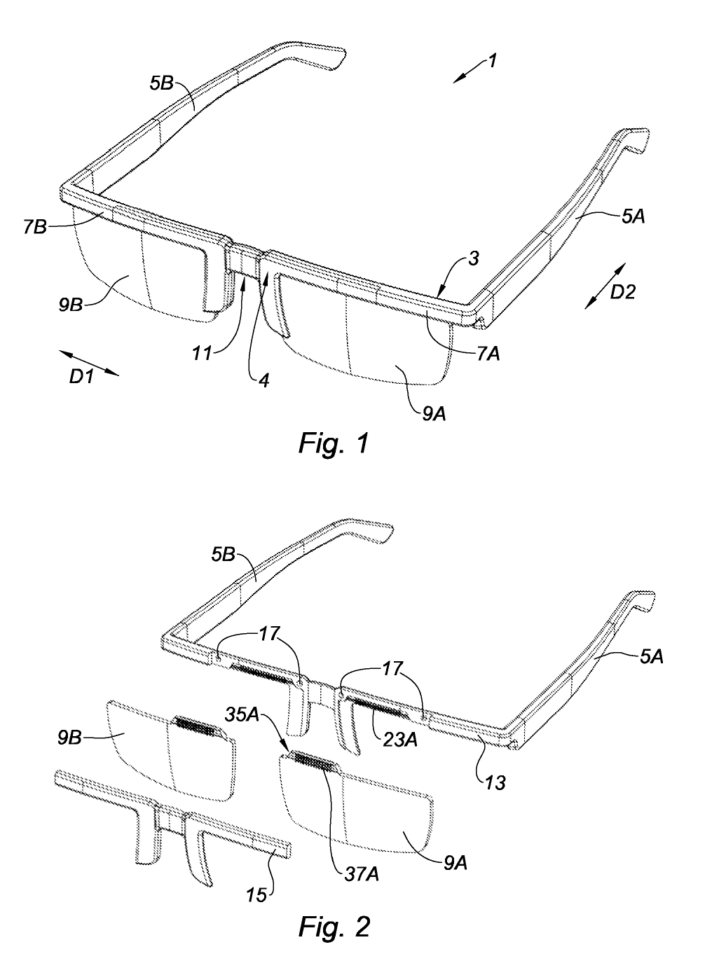

FIG. 1 represents a pair of spectacles 1 comprising a frame 3. The frame 3 comprises a front face 4 extending in an extension direction D1, a temple 5A and a temple 5B. In the use position, the temples 5A and 5B extend along an extension direction D2, transverse to the extension direction D1. The temple 5A is rotatably mounted around any of the ends of the front face 4 and the temple 5B is rotatably mounted around the other end of the front face 4.

The front face 4 comprises a receiving portion 7A of a lens 9A and a receiving portion 7B of a lens 9B. The front face 4 further comprises, between the receiving portions 7A, 7B of the lenses 9A, 9B, a bearing portion 11 intended to bear against the nose of a user.

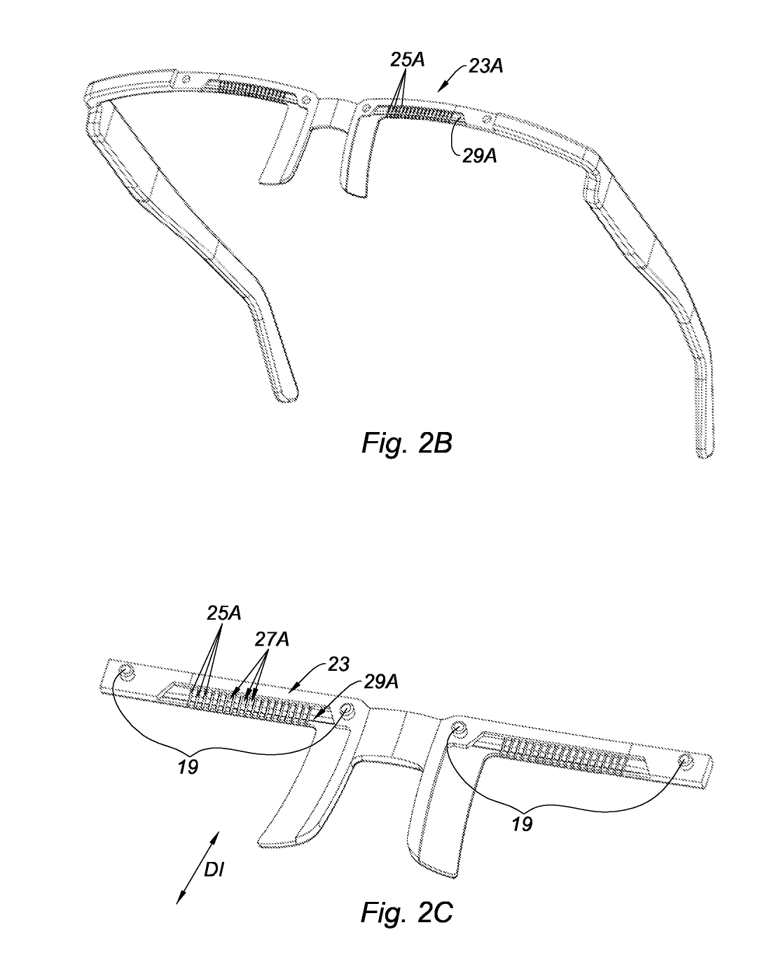

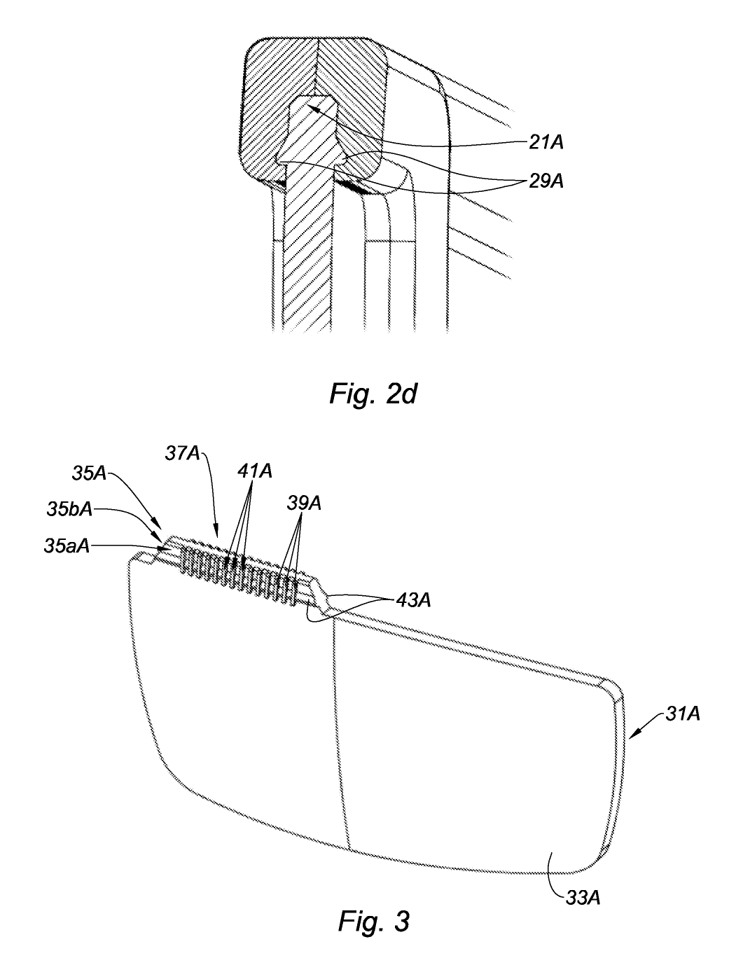

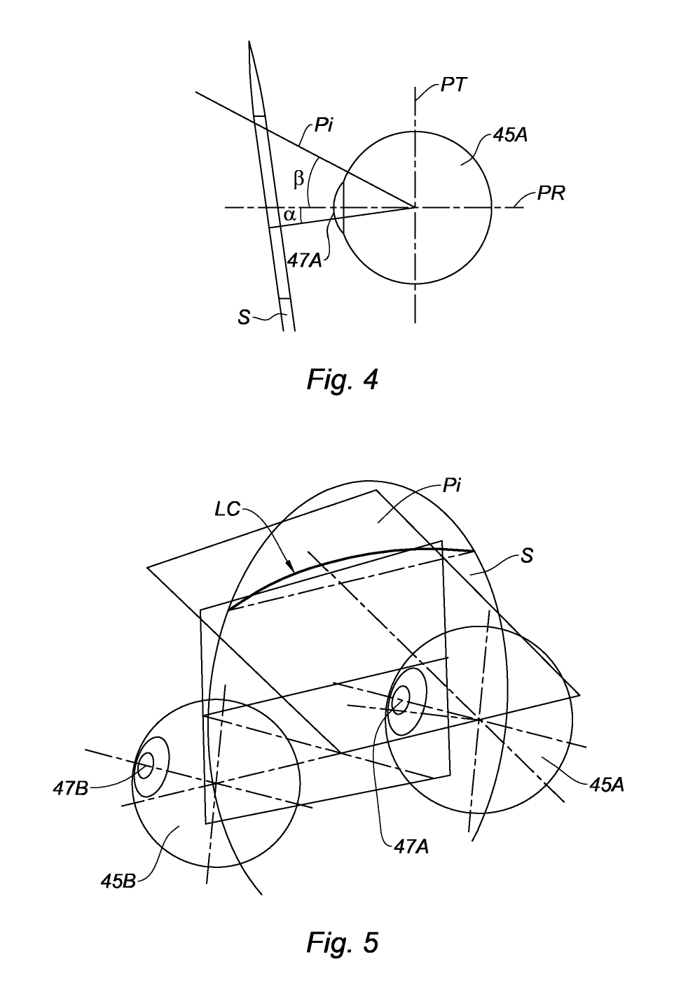

As represented in FIGS. 2a 2b and 2c, the front face 4 comprises two complementary parts. A first complementary part 13 is fastened to the temples 5a, 5b. A second complementary part 15 is intended to be fastened on the first complementary part 13 using complementary fastening elements 17, 19, for example by clipping.

The complementary parts 13, 15 of the front face 4 are formed of an elastic material, allowing their elastic deformation. For example, the front face is made of injected plastic material.

According to a variant, the front face is formed in one-piece part. It may, for example, be molded in its entirety.

As represented in FIG. 2d, once assembled, the complementary parts 13, 15 form receiving housings 21a, 21b of the lenses 9a, 9b comprised in the receiving portions 7a, 7b.

It should be noted that the elements whose reference contains the sign <<A>> relate to the receiving portion 7A or to the lens 9A and the elements whose reference contains the sign <<D>> relate to the receiving portion 7A or to the lens 9A. The receiving portions 7A and 7B or the lenses 9A and 9B have a substantially identical structure and operation. The present description will be limited, in some aspects, to describing in detail a receiving portion or a single lens among the receiving portions 7A, 7B or the lenses 9A, 9B respectively.

A detailed description of the receiving portion 7A and the lens 9A is provided hereinafter.

The receiving housing 21A is open along an insertion direction DI of the lens 9A in the housing 21A. The lateral walls of the receiving housing 21A comprise an adjusting system 23A, shown in FIGS. 2b and 2c. The first part 13 of the front face 4 comprises a first portion of the adjusting system 23A and the second part 15 of the front face 4 comprises a second portion of the adjusting system 23A.

Each portion of the adjusting system 23A comprises several catches 25A. Each catch 25A is of an elongated shape along the insertion direction DI. The catches 25A are aligned along a curved line LC. Each catch is distant from the neighboring catch in the alignment of catches of a spacing 27A. The spacing 27A is substantially greater than the width of the catches 25A.

According to an embodiment, the width of the catches may be about 1 millimeter. The alignment of catches has a length comprised between 1.5 and 2.5 centimeters. Preferably, the length of the alignment of catches has a value of about 2 centimeters.

As represented in FIGS. 2b and 2c, the receiving housing 21A further comprises, on each lateral face corresponding to the complementary parts 13, 15, a groove 29A extending along the curved line LC.

As represented in FIG. 3, the lens 9A comprises a proximal surface 31A and a distal surface 33A.

For example, the proximal surface 31A and the distal surface 33A are inscribed in a proximal sphere portion and a distal sphere portion, respectively, of different radius. The proximal and distal surfaces may also be inscribed in sphere portions of variable radii.

A median surface S is disposed between the proximal and distal surfaces.

The proximal, distal and median surfaces are spheroidal. For example, the radius of curvature of these surfaces may also be variable according to the considered point of the surface.

The lens 9A further comprises a protuberance 35A, allowing the mounting of the lens 9A in the receiving portion 7A of the front face 4, by being inserted into the receiving housing 21A. The protuberance 35A comprises two sides 35aA and 35bA each corresponding to a lateral surface of the receiving housing 21A.

The protuberance 35A comprises an adjusting system 37A. The adjusting system 37A comprises several catches 39A on each of the sides 35aA, 35bA of the protuberance 34A. The characteristics and the disposition of the catches 39A are substantially similar to the characteristics and the disposition of the catches 25A. Each catch 39A is distant from the neighboring catch in the alignment of catches of a spacing 41A.

The catches 39A are intended to be inserted into the spacings 27A. The catches 25A are intended to be inserted into the spacings 41A.

The protuberance 35A of the lens 9A further comprises a gadroon 43A on each of the sides 35aA, 35bA of the protuberance intended to be inserted into the groove 29A of the receiving housing 21A.

The curved line LC is a circle portion corresponding to the intersection of the median surface S and of an inclined plane PI. The median surface S being herein spheroidal, the curved line LC is a circle portion.

In the following description, a reference plane PR is defined. The reference plane PR passes through the optical axes of the eyes 45A, 45B of the user in far vision, that is to say through the center of the eyes 45A, 45B of the user and through the center of his pupils 47A, 47B in far vision.

The reference plane PR is therefore substantially horizontal when the user is standing. Furthermore, the term top means, the space located above the reference plane PR when the user is standing. The term <<bottom>> means, the space located below the reference plane PR when the user is standing.

The optical axis in near vision of the user is inclined downwards relative to the reference plane PR of a pantoscopic angle α.

The median surface S of the lens is also inclined at the pantoscopic angle α relative to a plane PT transverse to the reference plane, passing through the center of the two eyes 45A, 45B of the user.

The inclined plane P1 is inclined upwards at an angle β relative, on the one hand, to a straight line inscribed in the reference plane PR, passing through the center of the eye 45A and through the center of the pupil 47 and on the other hand, to a straight line inscribed in the reference plane PR, passing through the center of the eye 45B and through the center of the pupil 47B. The value of the angle β depends on the aesthetics of the frame 3.

The position of the lens 9A is adjustable on a path along the curved line LC. The adjusting systems 23A, 37A are arranged in order to index a plurality of relative positions of the lens 9A relative to the frame 3.

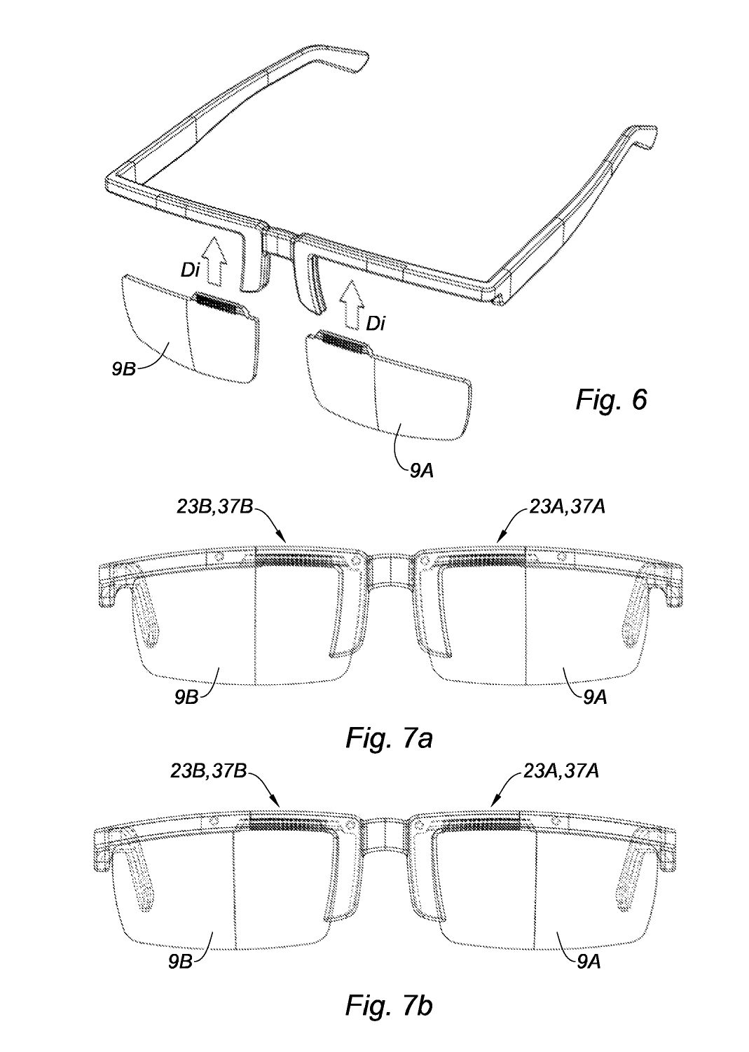

Indeed, during the mounting of the lens 9A on the frame 3, the user inserts the protuberance 35A of the lens 9A into the receiving housing 21A of the front face 4, along the insertion direction DI as represented in FIG. 6. The catches 39A of the adjusting system 37A are inserted into the spacings 27A of the adjusting system 23A according to the relative position of the lens 9A relative to the frame 3 chosen by the user. Conversely, the catches 25A of the adjusting system 23A are inserted into the spacings 41A of the adjusting system 37A.

As represented in FIG. 2d, the gadroon 43A is inserted into the groove 29A, which holds the lens 9A fastened to the frame 3. The insertion of the protuberance 35A of the lens 9A into the receiving housing 21A is carried out by pressure of the user. Indeed, the elasticity of the materials used to make the front face 4 allows the elastic deformation of the receiving housing 21A for the passage of the gadroon 43A, until it is inserted into the groove 29A.

In order to modify the relative position of the lens 9A relative to the frame 3, the user removes the protuberance 35A from the receiving housing 21A of the front face 4 by traction along the direction opposite to the insertion direction. The user may then reinsert the protuberance 35A of the lens 9A into the receiving housing 21A according to a different position. Each catch 39A of the adjusting system 37A is inserted into a spacing 27A of the different adjusting system 23A. Conversely, each catch 25A of the adjusting system 23A is inserted into a spacing 41A of the different adjusting system 37A.

FIGS. 7a and 7b represent the pair of spectacles 1 whose lenses 9A, 9B are in two different positions. The pupillary distance between the two positions varies by 4 mm.

Of course, the present invention is not limited to the described and represented embodiment, provided by way of illustrative and non-limiting example.

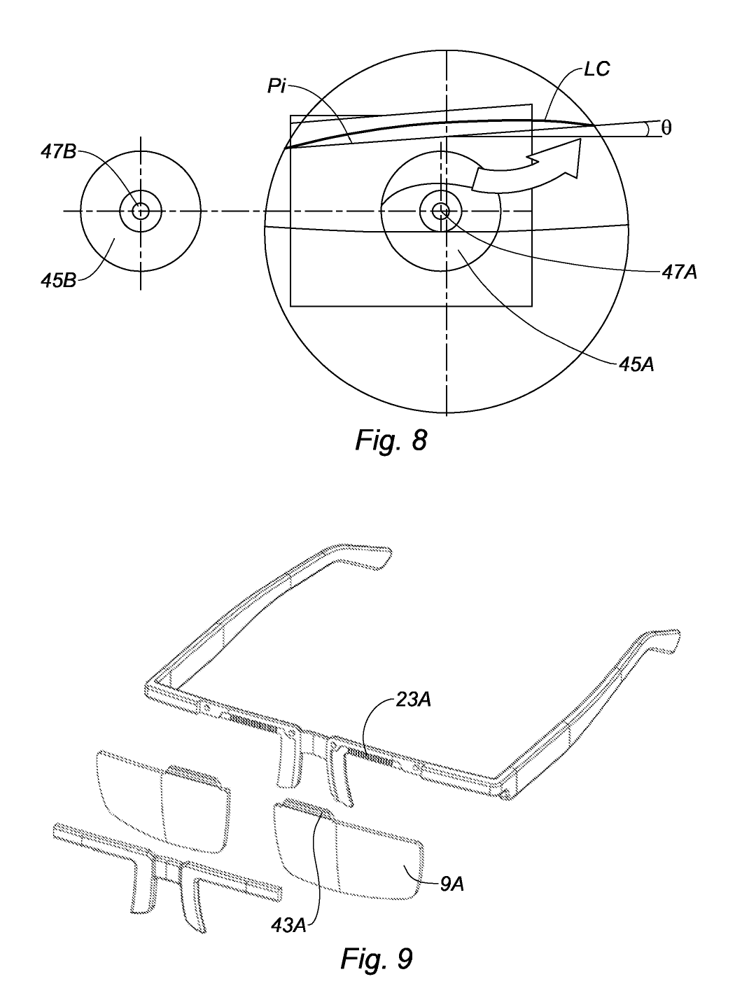

According to an embodiment represented in FIG. 8, the frame 3 has a shape called <<butterfly>>. In this case, the inclined plane P1 defining the curved line LC is inclined by an angle θ relative to the axis passing through the center of the two eyes 45A, 45B of the user.

According to an embodiment represented in FIG. 9, for increasing the rigidity of the frame, only one of the complementary parts 13, 15 is elastic. In this case, the adjusting systems 23A, 23B are present only on one of the complementary parts 13, 15 and the adjusting systems 37A, 37B are present only on the corresponding sides 35aA, 35bA, 35aB, 35bB of the protuberances 35A, 35B of the lenses 9A, 9B. The grooves 29A, 29B are present only on the elastic complementary part 13, 15 and the gadroons 43A, 43B are present only on the corresponding sides 35aA, 35bA, 35aB, 35bB of the protuberances 35A, 35B of the lenses 9A, 9B.

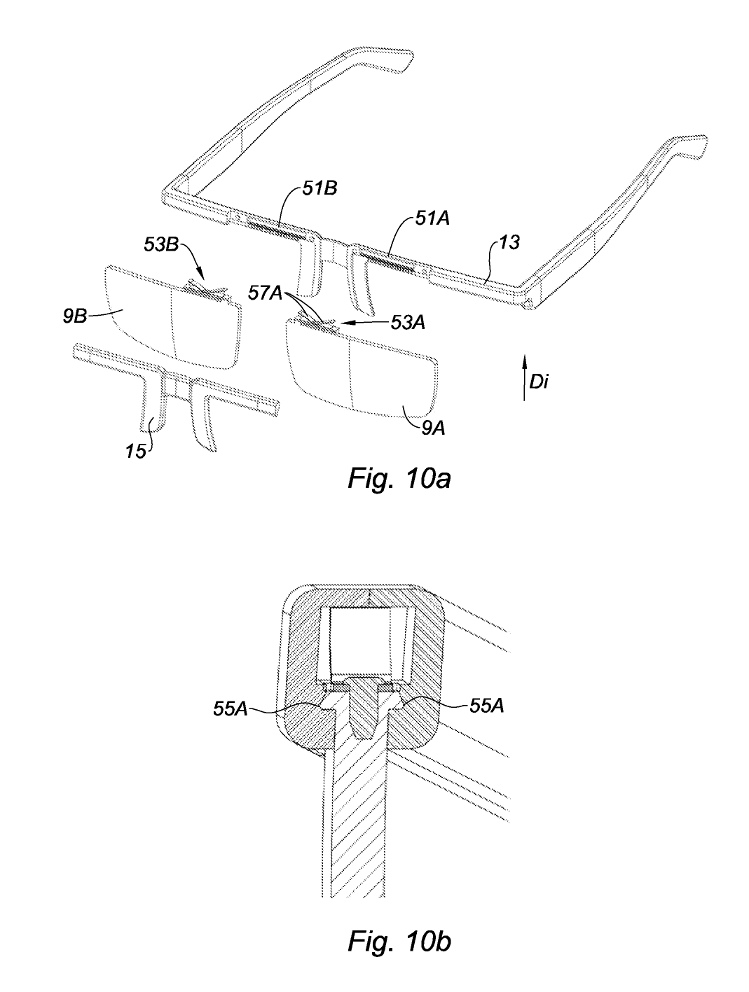

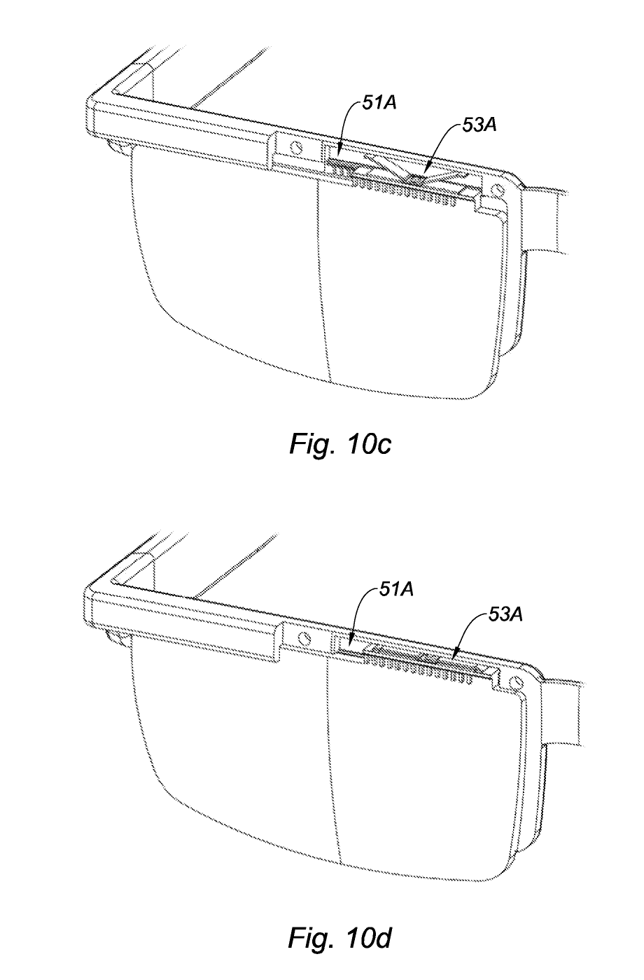

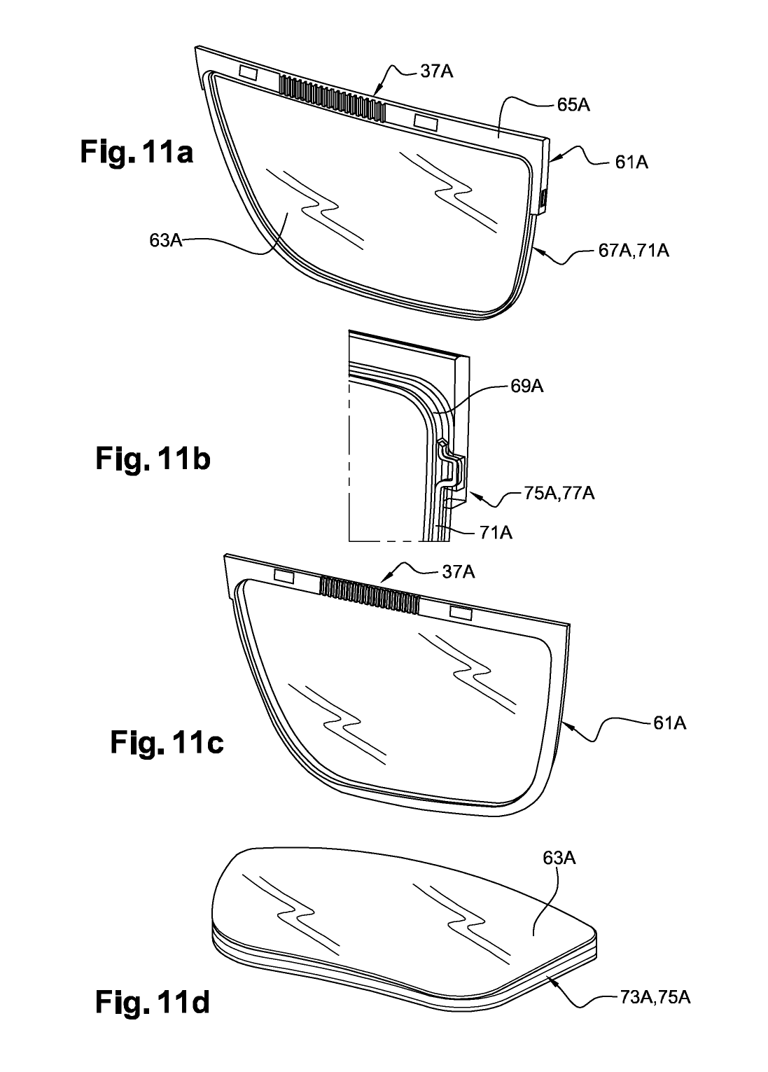

According to an embodiment represented in FIGS. 10a, 10b, 10c, 10d, the receiving housings 21A, 21B each comprise a clearance zone 51A, 51B respectively. The clearance zones 51A, 51B are disposed at the bottom of the receiving housings 21A, 21B, along the insertion direction DI, that is to say in the upper portions of the receiving housings 21A, 21B when the user is in a standing position. A spring blade 53A, 53B is fastened by screwing or heading of a cylinder issued from the lens, on an upper portion of each protuberance 35A, 35B of the lenses 9A, 9B. The spring blades 53A, 53B are arranged to be inserted into the clearance zones 51A, 51B.

The grooves 29A, 29B are adjacent to the clearance zones 51A, 51B. They are disposed between the clearance zones 51A, 51B and the adjusting systems 23A, 23B. The grooves 29A, 29B comprise an oblique portion 55A, 55B sliding towards the clearance zones 51A, 51B.

The gadroons 43A, 43B are disposed above the adjusting systems 37A, 37B.

Each spring blade 53A, 53B here includes two bearing portions 57A, 57B intended to bear against the upper face of the clearance zone 51A, 51B repelling the lenses 9A, 9B along a direction opposite to the insertion direction DI.

The lens 9A is definitively mounted in the receiving housing at the time of the mounting of the complementary parts 13, 15. The gadroon 43 is inserted into the groove 29A and the adjusting systems 23A and 37A cooperate.

The spring blade 53A is inserted into the clearance zone 51A and bears on its upper face.

When the complementary parts 13, 15 are fastened to each other, the lens 9A can no longer be disengaged from the frame 3.

In order to modify the relative position of the lens 9A, the user exerts a pressure on the lens 9A along the insertion direction DI. The bearing portions 57A of the spring blade 53A is flattened against the upper face of the clearance zone 51A and the gadroon 43A slides against the oblique portion 55A of the groove 29A in order to reach the clearance zone 51A. The user may therefore slide the lens 9A in the clearance zone 51A and when the relative position of the lens 9A relative to the frame 3 is convenient therefor, it releases the lens 9A, the bearing portions 57A of the spring blade 53A push the lens 9A along a direction opposite to the insertion direction DI, the adjusting systems 23A, 37A cooperate and the gadroon 43A is inserted into the groove 29A. The user may also exert a traction on the lens 9A in order to facilitate the positioning thereof.

The mounting of the lens 9B is carried out in a substantially identical manner.

According to an embodiment, the second complementary part 15 of the front face 4 may be fastened on an outer face of the first complementary part 13 or on an inner face of the first complementary part 13 of the front face 4, according to the desired aesthetics of the pair of spectacles.

According to an embodiment, the lenses 9A, 9B may be fully rimmed by the addition of a rim in the lower part, according to the desired aesthetics of the pair of spectacles. The rim may be made of plastic material or metal. The rim may be fastened to the lens 9A, 9B by gluing or mechanical nesting.

According to an embodiment of the invention, the lenses 9A comprise a framework 61A and an optical portion 63A. In the same manner as for the preceding embodiments, the receiving portions 7A and 7B or the lenses 9A and 9B have a substantially identical structure and operation. A description of the lens 9A will be presented hereinafter.

The framework 61A comprises the adjusting device 37A intended to adjust the position of the lens 9A relative to the frame 3. The framework 61A is disposed on the periphery, that is to say the contour, of the optical portion 63A. The framework 61A comprises a support 65A and a retaining element 67A. The support 65A comprises the adjusting device 37A. For example, the framework 61A comprises a metal portion.

The retaining element 67A comprises a protruding portion 69A formed with the support 65A on an upper portion of the framework 61A when the pair of spectacles is worn by a user standing such that his eyes are disposed at the same height relative to a horizontal reference.

The retaining element 67A comprises a nylon wire 71A on a lower portion of the frame 61A when the pair of spectacles is worn by a user standing such that his eyes are disposed at the same height relative to a horizontal reference.

According to a variant, the nylon wire 71A is disposed on an upper portion of the framework 61A and the support is disposed on a lower portion of the framework.

The optical portion 63A is therefore held by the framework 61A in a form-fitting manner.

The optical portion 63A comprises a retaining member 73A arranged in order to cooperate with the retaining element 67A of the framework 61A. The retaining member 73A comprises a slot 75A on the periphery of the optical portion 63A.

The frame 61A and the optical portion 63A are removably fastened.

The nylon wire 71A is removably fastened by fastening elements 75A of the support 65A at a nose pad of the spectacle frame and/or to the first temple 5A and/or to the second temple 5B. The fastening elements 75A of the support 65A comprise an opening 77A arranged to be crossed by the nylon wire 71A. Of course, the present invention is not limited to the described and represented embodiments, provided by way of illustrative and non-limiting examples.

1. A spectacle frame comprising:
a front face, on which the at least one lens is intended to be fastened;
a first temple and a second temple each attached on one end of the front face; and
a first adjusting device intended to adjust the position of the at least one lens relative to the front face of the frame, the first adjusting device comprising at least one first positioning element intended to cooperate with at least one second positioning element of a second adjusting device belonging to the at least one lens,
characterized in that the first adjusting device is arranged to define a set of relative positions of the at least one second positioning element relative to the frame disposed on a curved line (LC) comprised in an inclined plane (PI) relative to a reference plane (PR) comprising the optical axes in far vision of the eyes of a user.

2. A spectacle lens intended to be fastened to a frame, comprising a second adjusting device intended to adjust the position of the lens relative to the frame, the second adjusting device comprising at least one second positioning element intended to cooperate with at least one first positioning element of a first adjusting device belonging to the frame,
characterized in that the second adjusting device is arranged to define a set of relative positions of the at least one first positioning element relative to the lens disposed on a curved line (LC) comprised in an inclined plane (PI) relative to a reference plane (PR) comprising the optical axes in far vision of the eyes of a user.

3. The frame according to claim 1 wherein, the curved line (LC) is a circle portion.

4. The frame according to claim 1, wherein the inclined plane (PI) has a first component of inclination (β) relative to the reference plane (PR).

5. The frame according to claim 1 wherein, the inclined plane (PI) has a second component of inclination (θ) relative to a straight line passing through the center of the eyes of the user.

6. The frame according to claim 1 wherein, the at least one first positioning element and the second at least one positioning element are arranged to cooperate in a form-fitting manner.

7. The frame according to claim 1, further comprising a first plurality of first positioning elements and a plurality of second positioning elements.

8. The frame according to claim 7 wherein, spacing between two subsequent positioning elements among the first plurality of positioning elements or the second plurality of positioning element is arranged in order to index a plurality of relative positions between the frame.

9. The frame according to claim 7 wherein, a positioning element among the first plurality of positioning elements or the second plurality of positioning elements has an elongated shape in a direction transverse to the curved line (LC).

10. The frame according to claim 1, wherein the curved line (LC) is inscribed between a proximal surface (31A, 31B) and a distal surface of the at least one lens intended to be fastened on the frame.

11. The frame according to claim 1, wherein the profile of the front face follows the curved line (LC).

12. The lens according to claim 2, wherein the lens comprises a proximal face (31A, 31B) and a distal face between which the curved line (LC) is inscribed.

13. A pair of spectacles comprising a frame according to claim 1, and at least one lens, comprising:
a second adjusting device intended to adjust the position of the lens relative to the frame, the second adjusting device comprising at least one second positioning element intended to cooperate with at least one first positioning element of a first adjusting device belonging to the frame, wherein the second adjusting device is arranged to define a set of relative positions of the at least one first positioning element relative to the lens disposed on a curved line (LC) comprised in an inclined plane (PI) relative to a reference plane (PR) comprising the optical axes in far vision of the eyes of a user.

14. The lens according to claim 2 wherein, the curved line (LC) is a circle portion.

15. The lens according to claim 2, wherein the inclined plane (PI) has a first component of inclination (β) relative to the reference plane (PR).

16. The lens according to claim 2 wherein, the inclined plane (PI) has a second component of inclination (θ) relative to a straight line passing through the center of the eyes of the user.

17. The lens according to claim 2 wherein, the at least one first positioning element and the second at least one positioning element are arranged to cooperate in a form-fitting manner.

18. The lens according to claim 2, further comprising a first plurality of first positioning elements and a plurality of second positioning elements.

19. The lens according to claim 18 wherein, spacing between two subsequent positioning elements among the first plurality of positioning elements or the second plurality of positioning elements is arranged in order to index a plurality of relative positions between the frame.

20. The lens according to claim 18 wherein, a positioning element among the first plurality of positioning elements or the second plurality of positioning elements has an elongated shape in a direction transverse to the curved line (LC).
